(19) United States
(12) Patent Application Publication
(10) Pub. No.: US 2020/0037421 A1
(43) Pub. Date: Jan. 30, 2020

(54) SYSTEM FOR LIGHT COMMUNICATION WITH A LIGHTING DEVICE

(71) Applicant: SIGNIFY HOLDING B.V., EINDHOVEN (NL)

(72) Inventors: MARCEL BEIJ, SINT OEDENRODE (NL); LUCAS LOIS MARIE VOGELS, HERTEN (NL); ALDEGONDA LUCIA WEIJERS, EINDHOVEN (NL)

(21) Appl. No.: 16/484,255

(22) PCT Filed: Feb. 14, 2018
(86) PCT No.: PCT/EP2018/053662

§ 371 Date: Aug. 7, 2019

(30) Foreign Application Priority Data
Feb. 16, 2017 (EP) 17156416.4

(51) Int. Cl. H05B 37/02; H04B 10/116

(52) U.S. Cl. CPC H05B 37/0272; H04B 10/116; H05B 37/0227

(57) ABSTRACT

A system (1) is disclosed, which comprises a transmitting device (2) and a receiving device (3). The transmitting device (2) comprises a light source (4) configured to vary the intensity of the emitted light so as to include information in light (5) emitted by the light source (4). The receiving device (3) comprises a lighting device (7) configured to emit light at least during some periods of time. At least one light sensor (6) of the receiving device (3) is configured to sense light emitted by the light source (4) and convert it into at least one received signal. The receiving device (3) is configured such that the at least one light sensor (6) at least during some periods of time does not receive any light emitted by the lighting device (7). The at least one received signal can be processed so as to determine the information included in the light (5) emitted by the light source (4).

### TECHNICAL FIELD

The present invention relates a system and a method for light communication (e.g., visible light communication) between a transmitting device, comprising a light source, and a receiving device, comprising a lighting device configured to emit light at least during some periods of time.

### BACKGROUND

Circadian rhythms are biological processes which are observed inter alia in mammals and which govern activity/sleeping patterns. Circadian rhythms normally exhibit an oscillation with a period of about a day. Even though circadian rhythms are endogenously controlled, they are generally adjusted to the local environment by external factors such as ambient light. Disruption of the normal circadian rhythm in humans may have several causes, such as, for example, travelling across (multiple) time zones, which may cause the circadian rhythm to become unsynchronized with local time, and shift working. Disruption of the normal circadian rhythm in humans may for example cause sleep disturbances.

The use of solid state lighting devices, such as light-emitting diodes (LEDs), for illumination purposes continues to attract attention. Solid state lighting devices such as LEDs are employed in a wide range of lighting applications, such as, for example, general lighting. LEDs are advantageous since they may allow for a relatively simple control of the emitted light for example with respect to dimming and color setting. Some LED-based lighting devices may be capable of adjusting the intensity and color of the emitted light depending on the time during the day, the day of the year, and the geographical position of the lighting devices. Such LED-based lighting devices may in the following be referred to as circadian LED-based lighting devices.

Even though LED-based lighting devices may generally be capable of adjusting the intensity and color of the emitted light, for a circadian LED-based lighting device, such adjustment may be desired to be carried out based on the current time of day, throughout the year, and the geographical position of the circadian LED-based lighting device. Preferably, it should not matter where on Earth the circadian LED-based lighting device is located. Hence, a circadian LED-based lighting device should preferably ‘know’ these parameters, in order to adjust, e.g., the intensity and color of the emitted light, so that the intensity and color of the emitted light corresponds to the circadian rhythm of the user of the circadian LED-based lighting device. To this end, a clock may provide the correct time of day and day of the year, and a Global Positioning System (GPS) device may provide the geographical position of the user of the circadian LED-based lighting device. However, it is not always feasible to employ a GPS device due to shielding of the circadian LED-based lighting device e.g. by walls or roofs of a building in which the circadian LED-based lighting device is located. Furthermore, a GPS device may be relatively expensive, and may have a relatively large size, whereas a circadian LED-based lighting device should preferably be relatively inexpensive and have a relatively small size.

In order for the circadian LED-based lighting device to operate properly, a clock, e.g., included in the circadian LED-based lighting device, may provide the correct time of day and day of the year, and the geographical position of the user of the circadian LED-based lighting device may be provided by the user via some user interface the circadian LED-based lighting device. The required information i.e. the time of day and day of the year and/or the geographical position of the user of the circadian LED-based lighting device may be transmitted to the circadian LED-based lighting device and stored e.g. in a memory included in the circadian LED-based lighting device by way of a wired connection (e.g., cable), wirelessly, such as by means of Near Field Communication (NFC), Bluetooth, ZigBee, Wi-Fi or any other radio-frequency (RF) communication means, or buttons on the circadian LED-based lighting device, touch sensors, etc. Also, the required information may be transmitted to the circadian LED-based lighting device optically, e.g., by means of infrared (IR) light communication means. A disadvantage of such means for transmitting the required information to the circadian LED-based lighting device is that such means may not be readily available to the user. The user may hence possibly have to obtain some dedicated means for transmitting the required information in order for the circadian LED-based lighting device to operate properly.

In WO 2015/104408 a LED module is disclosed comprising a control unit for driving at least one LED. At least one LED is an emitting LED for emitting light, and least one LED is a sensing LED for sensing light and outputting a sensing signal according; to the sensed light. Based on the sensing signal, the control unit is configured to control a light output of the at least one emitting LED obtained from the at least one sensing LED.

### SUMMARY

Visible light communication uses visible light, e.g., light within a wavelength range of approximately 400 to 700 nm, in order to transmit information or data in a wireless fashion. In order to transmit information or data using visible light communications (or using light communications in another wavelength range), a transmitting device, including or being constituted by a visible light source such as, for example, a LED-based light source, may for example be switched such that light-emission from the transmitting device is alternatingly turned on and off, e.g., intensity modulated, or encoded. A receiving device (e.g., a light sensor or photodetector) may receive the intensity modulated light emitted by the transmitting device and convert it into signal(s) that may subsequently be further processed in order to determine the transmitted information or data. The intensity modulated light that is emitted by the transmitting device may be referred to as coded visible light. Coded visible light is hence based on including (e.g., embedding, or encoding) of information or data in the light output of the visible light source. The information or data included or embedded in the light output should preferably not or only to a small extent influence the main lighting function(s) of the visible light source. The intensity modulation of the light emitted by the transmitting device should therefore preferably not be perceivable by the naked eye of a human. As an example, US 2015/0174361 A1 discloses that communication between various components of a lighting system and/or other devices may utilize one or more communications mediums which may include a wireless link using infrared, microwave or encoded visible light transmissions and any suitable transmitters, receivers or transceivers.

In view of the above discussion, a concern of the present invention is to provide means for transmitting information from a transmitting device to a receiving device, which receiving device includes a lighting device such as, for example, a circadian LED-based lighting device, and which information facilitates adjustment or control of the light output from the lighting device based on, e.g., the current time of day, throughout the year, and the geographical position of the lighting device.

To address at least one of this concern and other concerns, a system in accordance with the independent claim is provided. Preferred embodiments are defined by the dependent claims.

According to a first aspect of the present invention there is provided a system comprising a transmitting device. The transmitting device comprises a light source configured to vary (or fluctuate) the intensity of the light emitted by the light source so as to include (e.g., embed, or encode) information in light emitted by the light source. The system comprises a receiving device. The receiving device comprises a lighting device configured to (possibly controllably) emit light at least during some periods of time. The receiving device comprises at least one light sensor. The at least one light sensor is configured to sense light at least within a wavelength range of light emitted by the light source of the transmitting device (and which may be impinging on the at least one light sensor) and convert the sensed light into at least one received signal. The receiving device comprises a processor configured to process the at least one received signal so as to determine the information included in the light emitted by the light source.

The system may hence facilitate or enable light communication between a transmitting device and a receiving device. Since the receiving device comprises a lighting device which may emit light, the at least one light sensor may receive, or sense, light emitted by the lighting device. This situation may however be addressed for example by the lighting device being configured to not emit light during the plurality of second sequential periods of time, and by the at least one light sensor being configured to receive, or sense, light emitted by the light source of the transmitting device during the plurality of second periods of time.

During the plurality of second periods of time, the lighting device is configured to not emit light, and hence the at least one light sensor will not receive, or sense, light emitted by the lighting device during the plurality of second periods of time. The plurality of second periods of time can hence be considered as time ‘windows’ during which the at least one light sensor will not be ‘disturbed’ by light emitted by the lighting device, and during which information included in the light emitted by the light source of the transmitting device can be transferred from the transmitting device to the receiving device.

Thus, according to an example, and in accordance with one or more embodiments of the present invention, the lighting device of the receiving device may be configured to controllably emit light or to not emit light. The lighting device may be configured to emit light during a plurality of first sequential periods of time and to not emit light during a plurality of second sequential periods of time. The at least one light sensor may be configured to receive, or sense, light emitted by the light source of the transmitting device during the plurality of second periods of time.

By the at least one light sensor being configured to receive, or sense, light emitted by the light source of the transmitting device during the plurality of second periods of time, it is meant that the at least one light sensor is configured to carry out light sensing operation during the plurality of second periods of time, i.e. when the lighting device of the receiving device is not emitting light. During the plurality of second periods of time, the at least one light sensor may or may not receive light emitted by the light source of the transmitting device, depending on whether the light source of the transmitting device is emitting (intensity varied) light during the plurality of second periods of time.

According to another example, and in accordance with one or more embodiments of the present invention, the lighting device of the receiving device may in alternative or in addition be configured to emit light within at least one wavelength range. The at least one light sensor may be configured to not sense any light within the at least one wavelength range of light emitted by the lighting device. Thereby, the at least one light sensor may not be ‘sensitive’ to light emitted by the lighting device, and may (only) be sensitive to light emitted by the light source of the transmitting device. To that end, the at least one light sensor may for example comprise at least one wavelength-selective optical filter configured to not transmit, or block, light emitted by the lighting device, and transmit light emitted by the light source of the transmitting device. The at least one wavelength-selective optical filter could for example comprise a dichroic filter, or dichroic mirror. Thus, the lighting device may not necessarily be configured to not emit light during certain periods of time.

The lighting device of the receiving device may for example comprise a LED-based lighting device, but is not limited thereto.

The light source may for example be configured to intensity modulate the light emitted by the light source, thereby varying the intensity of the light emitted by the light source, so as to include information in the light emitted by the light source.

The light source may be configured to vary (or fluctuate) the intensity of the light emitted by the light source so as to include or embed information in the light emitted by the light source for example by means of a method for encoding the information into the light emitted by the light source as known in the art. Furthermore, the processor may be configured to process the at least one received signal so as to determine the information included in the light emitted by the light source for example by means of a method for decoding the information into the light emitted by the light source as known in the art.

The at least one light sensor may be configured to sense light only within a wavelength range of light that is emitted by the light source of the transmitting device.

The light source of the transmitting device may be configured to emit light, e.g., within wavelength range of approximately 400 to 700 nm. Thus, the light source of the transmitting device may be configured to emit visible light. The light source of the transmitting device is however not limited thereto, but may, in alternative or in addition and in accordance with one or more embodiments of the present invention, be configured to emit infrared light and/or light within another wavelength range than visible light or infrared light. For example, the light source of the transmitting device may be configured to emit within the near-infrared wavelength range (e.g., between about 750 nm and 1400 nm). According to one or more embodiments of the present invention, the light source of the transmitting device may be configured to emit light within wavelength range of approximately 400 to 1000 nm

The at least one light sensor may for example comprise, or be constituted by, at least one photosensor, which for example may include or be constituted by at least one photoelectric photosensor.

The at least one light sensor may be communicatively coupled or connected with the lighting device and/or the processor, employing for example any appropriate wired and/or wireless communication technique or means known in the art.

The processor of the receiving device may for example include or be constituted by any suitable central processing unit (CPU), microcontroller, digital signal processor (DSP), Application Specific Integrated Circuit (ASIC), Field Programmable Gate Array (FPGA), etc., or any combination thereof. The processor may optionally be capable of executing software instructions stored in a computer program product e.g. in the form of a memory. The memory may for example be any combination of read and write memory (RAM) and read only memory (ROM). The memory may comprise persistent storage, which for example can be a magnetic memory, an optical memory, a solid state memory or a remotely mounted memory, or any combination thereof.

The at least one light sensor may, according to one or more embodiments of the present invention, be configured to receive, or sense, light emitted by the light source of the transmitting device only during the plurality of second periods of time.

The information included in the light emitted by the light source of the transmitting device may for example comprise information that can be used to control operation of the lighting device of the receiving device. The information included in the light emitted by the light source may for example comprise information regarding the date and/or the local time at the geographical location of the transmitting device.

According to one or more embodiments of the present invention, the processor of the receiving device may be configured to control operation of the lighting device of the receiving device on the basis of the determined information. To this end, the processor may be communicatively coupled or connected with the lighting device, employing for example any appropriate wired and/or wireless communication technique or means known in the art. The processor of the receiving device may or may not be included in the lighting device.

The processor of the receiving device may for example be configured to control at least one of intensity and color of the light emitted by the lighting device of the receiving device. In alternative or in addition, one or more other aspects, characteristics or parameters of the light emitted by the lighting device of the receiving device may be controlled by the processor.

The transmitting device may be configured to determine the date and the local time at the geographical location of the transmitting device. To that end, the transmitting device may for example be capable of being coupled to a communications network such as, for example, the Internet, wherein the date and the local time at the geographical location of the transmitting device may be determined by the transmitting device by the transmitting device retrieving the date and the local time at the geographical location of the transmitting device from the communications network. According to an example, the transmitting device may be configured to determine the geographical location of the transmitting device (e.g., by the transmitting device retrieving the geographical location of the transmitting device from a communications network), and based on the geographical location of the transmitting device determine the date and the local time at the geographical location of the transmitting device. The information included in the light emitted by the light source may for example comprise information regarding the geographical location of the transmitting device.

The processor of the receiving device may for example be configured to control at least one of intensity and color of the light emitted by the lighting device of the receiving device on the basis of the geographical location of the transmitting device and the date and the local time at the geographical location of the transmitting device. The lighting device of the receiving device may for example be a circadian lighting device, such as, for example, a circadian LED-based lighting device. Thus, the light output from the lighting device of the receiving device may for example be controlled with respect to intensity and color so that the intensity and color of the light output from the lighting device of the receiving device corresponds to the circadian rhythm of the user of the lighting device (or receiving device).

In alternative or in addition, the information included in the light emitted by the light source of the transmitting device may for example comprise information that can be used to (possibly automatically) control operation of the lighting device of the receiving device according to a desired or required light setting of the lighting device. For example, the information may for example comprise control settings or parameters for controlling the lighting device so as to emit light having a certain color, intensity, luminous flux and/or another or other characteristics of the light emitted by the lighting device. The desired or required light setting of the lighting device may correspond to the location of the lighting device and a user of the transmitting device for example in a building. There may be different control settings or parameters for different locations in the building, for example so as to provide different light settings of the lighting device depending on whether the lighting device and the user of the transmitting device are located in a kitchen, in a bathroom, or in any other room in the building.

The plurality of first sequential periods of time may be non-consecutive. The plurality of second sequential periods of time may be non-consecutive. At least some of the plurality of first sequential periods of time and at least some of the plurality of second sequential periods of time may together form a continuous period of time, wherein each of said second periods of time may be between two of said first periods of time.

The durations of the plurality of first sequential periods of time may be the same. The durations of the plurality of second sequential periods of time may be the same.

The duration of the respective ones of the plurality of second sequential periods of time may for example be 1/20 or less of the duration of the respective ones of the plurality of first sequential periods of time.

As mentioned in the foregoing, the lighting device of the receiving device may for example comprise a LED-based lighting device, but is not limited thereto. LED(s) or LED-based lighting devices may for example be Pulse Width Modulation (PWM) dimmed. This may entail that the light emission from the LED(s) is switched on and off cyclically or repeatedly for certain durations. For LED(s) or LED-based lighting devices, a PWM frequency of (about) 1 kHz may for example be used, corresponding to repetitive time periods of 1 ms. By always switching the LED(s) or LED-based lighting devices off during each 1 ms time period for, e.g., 50 μs (i.e. 1/20 of the 1 ms time period), time ‘windows’ may be created during which the at least one light sensor will not be ‘disturbed’ by light emitted by the lighting device, and during which information included in the light emitted by the light source of the transmitting device can be transferred from the transmitting device to the receiving device.

The light source of the transmitting device may be configured to vary the intensity of the light (e.g., intensity modulate the light) emitted by the light source such that the intensity variation of the emitted light cannot be perceived by the naked eye of a human.

However, in accordance with one or more embodiments of the present invention, the light source of the transmitting device may be configured to vary the intensity of the light emitted by the light source such that the intensity variation of the emitted light can be perceived by the naked eye of a human. By the intensity variation of the emitted light being perceivable by the naked eye of a human, it may be indicated to a user of, e.g., the transmitting device, that the light source of the transmitting device is transmitting information.

The transmitting device may comprise a display, or screen, configured to emit light. The light source of the transmitting device may be included in, or be constituted by, the display.

According to one or more embodiments of the present invention, the transmitting device may comprise a smartphone. The light source of the transmitting device may for example be included in, or be constituted by, a light source of the smartphone. The light source of the smartphone may for example comprise or be constituted by a display of the smartphone and/or a so called flashlight of the smartphone.

By fluctuating or varying the intensity of light emitted by the light source of the smartphone, e.g., the smartphone's display or the smartphone's flashlight, a digital, low-baud rate signal may be transmitted from the light source of the smartphone to the at least one light sensor of the receiving device. For a smartphone's display or a smartphone's flashlight, the baud rate may be limited to 25 Hz, or about 25 Hz.

The smartphone may have access to one or more communication networks, such as, for example, the Internet. The smartphone may be configured to be coupled to a communication network. The communications network may allow or facilitate for the smartphone to retrieve information indicative of the date and the local time at the geographical location of the transmitting device. The smartphone may be configured to retrieve the information indicative of the date and the local time at the geographical location of the transmitting device from the communications network. The communications network may for example be a public communications network such as, for example, the Internet.

In the context of the present application, by a smartphone it is meant, e.g., a mobile phone built on a mobile operating system having functionality including one or several of a portable media player, an imaging device such as a digital camera, Global Positioning System (GPS) navigation unit, etc., combined with the functionality of a mobile phone. Smartphones may include a user interface, e.g., including a touch-sensitive screen or the like, capable of displaying e.g. web browsers that can display standard web pages as well as web pages optimized for viewing by a mobile device, and be capable of transmitting and receiving signals, data, etc., e.g., by means of Wi-Fi. The mobile operating systems used by a smartphone may include Android from Google, iOS from Apple, Symbian from Nokia, BlackBerry OS from RIM (“Research in Motion”), etc.

The smartphone may for example be provided with an application that (possibly automatically) retrieves the geographical location of the transmitting device via a communications network, and, based on the geographical location of the transmitting device, determines the date and the local time at the geographical location of the smartphone. The application may in alternative or in addition be configured to (possibly automatically) directly retrieve the date and the local time at the geographical location of the smartphone. The information indicative of the date and the local time at the geographical location of the transmitting device may in alternative or in addition be retrieved in other ways. For example, a user of the transmitting device may input the information manually, e.g., by means of a user interface configured to receive user input from the user.

According to a second aspect there is provided a transmitting device comprising a light source configured to vary the intensity of the light emitted by the light source so as to include information in light emitted by the light source. The transmitting device is configured to be used in conjunction with a system according to the first aspect.

According to a third aspect there is provided a receiving device configured to be used in conjunction with a system according to the first aspect and to receive light emitted by the light source of a transmitting device according to the second aspect. The lighting device is configured to (possibly controllably) emit light at least during some periods of time. The receiving device comprises at least one light sensor configured to sense light at least within a wavelength range of light emitted by the light source of the transmitting device (e.g., impinging on the at least one light sensor) and convert the sensed light into at least one received signal. The receiving device is configured such that the at least one light sensor at least during some periods of time does not receive any light emitted by the lighting device. The receiving device comprises a processor configured to process the at least one received signal so as to determine the information included in the light emitted by the light source.

According to a fourth aspect there is provided a method for light communication between a transmitting device, comprising a light source, and a receiving device, comprising a lighting device configured to (possibly controllably) emit light at least during some periods of time. The receiving device comprises at least one light sensor, configured to sense light at least within a wavelength range of light emitted by the light source of the transmitting device (e.g., impinging on the at least one light sensor). The receiving device is configured such that the at least one light sensor at least during some periods of time does not receive any light emitted by the lighting device. The method comprises varying the intensity of the light emitted by the light source so as to include information in light emitted by the light source. The method comprises the at least one light sensor sensing light at least within a wavelength range of light emitted by the light source of the transmitting device. The method comprises processing the at least one received signal so as to determine the information in the light emitted by the light source.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the invention will be described below with reference to the accompanying drawings.

FIG. 1 is a schematic view of a system according to an embodiment of the present invention.

FIG. 2 is a schematic view of a transmitting device in accordance with an embodiment of the present invention.

FIG. 3 is a schematic view illustrating principles of one or more embodiments of the present invention.

FIG. 4 is a schematic flowchart of a method according to an embodiment of the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

FIG. 1 is a schematic view of a system 1 according to an embodiment of the present invention. The system 1 comprises a transmitting device 2 and a receiving device 3.

The transmitting device 2 comprises a visible light source 4, which is configured to vary the intensity of the light emitted by the visible light source 4 so as to include or embed information in light 5 emitted by the visible light source 4. It is to be understood that the light source 4 may not be only configured to emit visible light. The light source 4 may for example in alternative or in addition be configured to emit near-infrared light (e.g., within a wavelength range of about 0.75 μm to 1.4 μm). Even though the light source 4 in the following with reference to the figures is referred to as a visible light source, it is to be understood that this is for exemplifying reasons and does not limit the illustrated embodiments of the present invention to the light source 4 emitting visible light, which light source 4 may, in accordance with one or more embodiments of the present invention, for example in alternative or in addition be configured to emit infrared light, such as near-infrared light. The visible light source 4 may for example be configured to intensity modulate the light emitted by the visible light source 4 thereby varying the intensity of the light emitted by the visible light source 4 so as to include information in light 5 emitted by the visible light source 4.

The receiving device 3 comprises a lighting device 7. The lighting device 7 is configured to controllably emit light or to not emit light. The lighting device 7 is configured to emit light during a plurality of first sequential periods of time and to not emit light during a plurality of second sequential periods of time.

The receiving device 3 comprises a light sensor 6, which is configured to sense light at least within a wavelength range of light emitted by the visible light source 4 of the transmitting device 2 and convert the sensed light into at least one received signal. The light sensor 6 may for example comprise, or be constituted by, at least one photosensor. The at least one photosensor may for example include or be constituted by at least one photoelectric photosensor, but is not limited thereto.

The light sensor 6 is configured to receive, or sense, light emitted by the visible light source 4 of the transmitting device 2 during the plurality of second periods of time. The light sensor 6 may, according to one or more embodiments of the present invention, be configured to receive, or sense, light emitted by the visible light source 4 of the transmitting device 2 only during the plurality of second periods of time.

According to another example, the lighting device 7 may not necessarily be configured to not emit light during certain periods of time. In alternative or in addition, the lighting device 7 may be configured to emit light within at least one wavelength range, and the light sensor 6 may be configured to not sense any light within the at least one wavelength range of light emitted by the lighting device 7. Thereby, the light sensor 6 may not be ‘sensitive’ to light emitted by the lighting device 7, and may (only) be sensitive to light emitted by the light source 4 of the transmitting device 2. The light sensor could for example comprise at least one wavelength-selective optical filter (not shown in FIG. 1) configured to not transmit, or block, light emitted by the lighting device 7, and transmit light emitted by the light source 4 of the transmitting device 2.

The receiving device 3 comprises a processor 8, which is configured to process the at least one received signal so as to determine the information included in the light emitted by the visible light source 4.

The processor 8 may be communicatively coupled or connected with the lighting device 7 and the light sensor 6 for communication of data, signals, messages, etc. between the processor 8 and the lighting device 7 and the light sensor 6, respectively. Although there in FIG. 1 are indicated wired connections between the processor 8 and the lighting device 7 and the light sensor 6, respectively, it is to be understood that the communicative coupling or connection between the processor 8 and the lighting device 7 and the light sensor 6, respectively, may employ for example any appropriate wired and/or wireless communication technique known in the art.

According to one or more embodiments of the present invention, the transmitting device 2 may for example comprise a smartphone (and/or another type of ‘smart’ device similar to a smartphone). The visible light source 4 of the transmitting device 2 may for example be included in, or be constituted by, a light source of the smartphone. The light source of the smartphone for example may comprise or be constituted by a display of the smartphone and/or a so called flashlight of the smartphone.

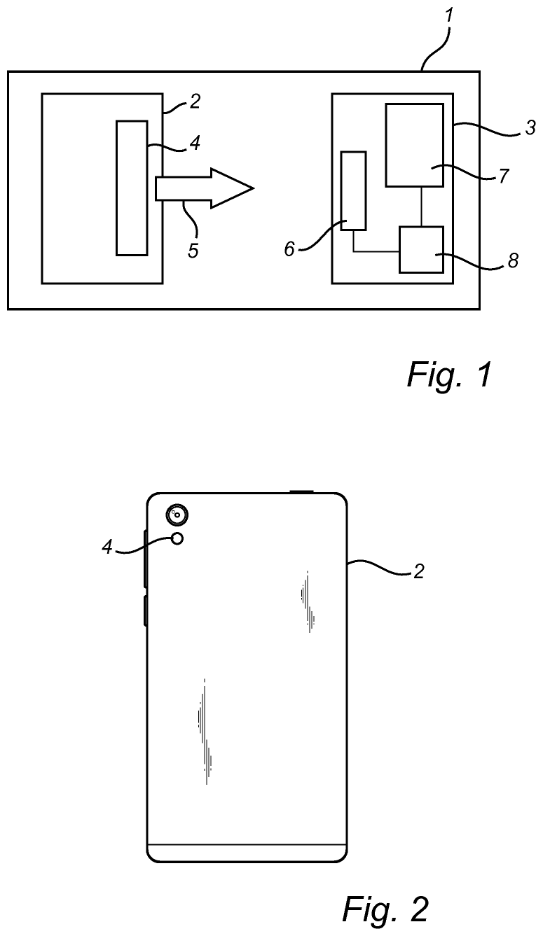

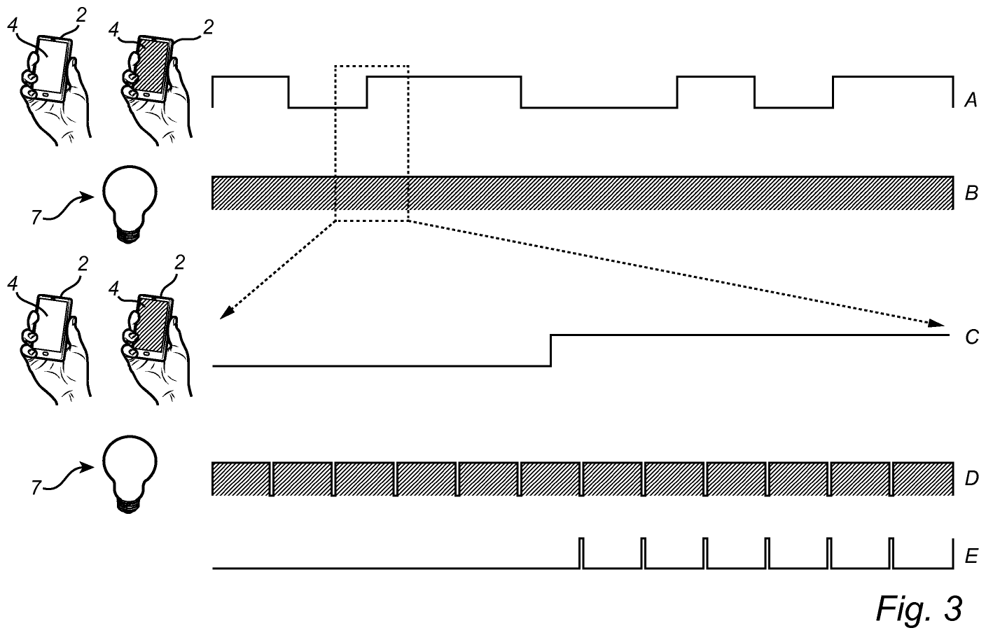

FIG. 2 is a schematic view of a transmitting device 2 in accordance with an embodiment of the present invention. The transmitting device 2 illustrated in FIG. 2 is configured to be used in conjunction with a system according to one or more embodiments of the present invention, such as the system 1 illustrated in FIG. 1. The transmitting device 2 illustrated in FIG. 2 is similar to the transmitting device 2 illustrated in FIG. 1. The transmitting devices 2 illustrated in FIGS. 1 and 2 have similar function. According to the embodiment of the present invention illustrated in FIG. 2, the transmitting device 2 comprises a smartphone 2, wherein the visible light source 4 of the transmitting device 2 comprises a so called flashlight 4 of the smartphone 2. In alternative or in addition the visible light source of the transmitting device 2 may comprise or be constituted by a display, or screen, of the smartphone 2 (not shown in FIG. 2; cf. FIG. 3).

The smartphone 2 may have access to one or more communication networks, such as, for example, the Internet. The smartphone 2 may be configured to be coupled to a communication network (such as the Internet) which may allow or facilitate for the smartphone 2 to retrieve (possibly automatically) information indicative of the date and the local time at the geographical location of the smartphone 2. The smartphone 2 may for example be provided with an application that (possibly automatically) retrieves the geographical location of the smartphone 2 via the communications network, and, based on the geographical location of the smartphone 2, determines the date and the local time at the geographical location of the smartphone 2. The application may in alternative or in addition be configured to (possibly automatically) directly retrieve the date and the local time at the geographical location of the smartphone 2. The information indicative of the date and the local time at the geographical location of the smartphone 2 may in alternative or in addition be retrieved in other ways, for example by means of a user of the smartphone 2 inputting the information manually, e.g., by means of a user interface of the smartphone 2 (not shown in FIG. 2) configured to receive user input from the user. The user interface may for example be comprised by a touch-sensitive screen or display, which the smartphone 2 may comprise. The touch-sensitive screen or display may constitute the visible light source of the smartphone.

FIG. 3 is a schematic view which illustrates principles of one or more embodiments of the present invention. According to the embodiment of the present invention illustrated in FIG. 3, the transmitting device 2 comprises a smartphone 2, which is similar or identical to the smartphone 2 illustrated in FIG. 2, having the same or similar function. Further according to the embodiment of the present invention illustrated in FIG. 3, the visible light source 4 of the transmitting device 2 is constituted by a display 4 of the smartphone 2.

Further according to the embodiment of the present invention illustrated in FIG. 3, the receiving device comprises a lighting device schematically indicated in FIG. 3 by the reference numeral 7. The lighting device 7 may for example be a circadian lighting device, such as, for example, a circadian LED-based lighting device. A processor of the receiving device (not shown in FIG. 3) may be configured to control at least one of intensity and color of the light emitted by the lighting device 7. The processor may or may not be included in the lighting device 7. The light output from the lighting device 7 may thereby be controlled with respect to intensity and color so that the intensity and color of the light output from the lighting device 7 corresponds to the circadian rhythm of a user of the lighting device 7. The user of the lighting device 7 may also be the user of the smartphone 2.

By fluctuating or varying the intensity of light emitted by the display 4 of the smartphone 2, information may be included in light emitted by the display 4 of the smartphone 2. Light emitted by the display 4 of the smartphone 2 could thereby be considered as a digital, low-baud rate signal which can be transmitted from the display 4 of the smartphone 2 to a light sensor of the receiving device (not shown in FIG. 3). The baud rate of the signal transmitted from the display 4 of the smartphone 2 may be limited to 25 Hz, or about 25 Hz.

The information included in the light emitted by the display 4 of the smartphone 2 may comprise information that can be used to control operation of the lighting device 7. The processor of the receiving device may for example be configured to control at least one of intensity and color of the light emitted by the lighting device 7 on the basis of the geographical location of the smartphone 2 and the date and the local time at the geographical location of the smartphone 2. To that end, the smartphone 2 may be configured to determine the date and the local time at the geographical location of the smartphone 2, e.g., by the smartphone 2 accessing a communication network such as the Internet and retrieving the information via the communication network. Thus, the information included in the light emitted by the display 4 of the smartphone 2 may for example comprise information regarding the date and the local time at the geographical location of the smartphone 2.

In accordance with the embodiment of the present invention illustrated in FIG. 3, by fluctuating or varying the intensity of light emitted by the display 4 of the smartphone 2, a light time pattern in which the information is included or contained may be generated, which light time pattern is illustrated in FIG. 3 at “A”. The light time pattern A includes a series of light pulses of certain durations when the display 4 of the smartphone 2 is switched on so that it emits light. Between the light pulses there are periods when the display 4 of the smartphone 2 is switched off so that it does not emit light, as indicated by the illustrations of the smartphone 2 next to the light time pattern A.

Further in accordance with the embodiment of the present invention illustrated in FIG. 3, the lighting device 7 comprises a LED-based lighting device which is PWM dimmed. The light emission from the lighting device 7 is switched on and off repeatedly for certain durations. For example, a PWM frequency of (about) 1 kHz may for example be used, corresponding to repetitive time periods of 1 ms. By switching the lighting device 7 off during each 1 ms time period for, e.g., 50 μs (i.e. 1/20 of the 1 ms time period), time ‘windows’ may be created during which light sensor will not be ‘disturbed’ by light emitted by the lighting device 7, and during which information included in the light emitted by the display 4 of the smartphone 2 can be transferred from the smartphone 2 to the receiving device. For the naked eye of a human, the light output from the lighting device 7 is continuous, or non-interrupted, as indicated by the light time pattern illustrated in FIG. 3 at “B”.

The light time patterns illustrated in FIG. 3 at “C” and “D” represent the portions of the light time patterns A and B, respectively, which are within the dashed rectangle in FIG. 3. That is to say, the light time patterns C and D represent the portions of the light time patterns A and B, respectively, within the duration of time indicated by the horizontal length of the dashed rectangle in FIG. 3. On the time scale of the illustrated light time pattern D (as compared to the time scale of the illustrated light time pattern A), the above-mentioned time ‘windows’ of 50 μs during which the lighting device 7 does not emit light are indicated in the light time pattern D. During those time ‘windows’, the information included in the light emitted by the display 4 of the smartphone 2 can be transferred from the smartphone 2 to the receiving device. The light time pattern illustrated in FIG. 3 at “E” represents the light that is emitted by the display 4 of the smartphone 2 and which during the above-mentioned time ‘windows’ is received, or sensed, by the light sensor of the receiving device. Since during the above-mentioned time ‘windows’ the lighting device 7 is switched off, as indicated by the light pattern D, the light sensor will not be ‘disturbed’ by light emitted by the lighting device 7 during the time ‘windows’, thus facilitating or allowing for the information included in the light emitted by the display 4 of the smartphone 2 to be transmitted to the receiving device.

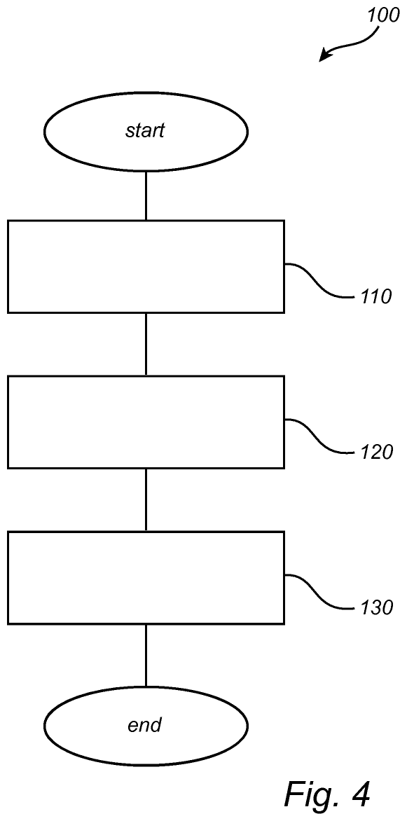

FIG. 4 is a schematic flowchart of a method 100 according to an embodiment of the present invention for light communication between a transmitting device comprising a light source and a receiving device comprising a lighting device configured to (possibly controllably) emit light at least during some periods of time. The receiving device comprises at least one light sensor configured to sense light at least within a wavelength range of light emitted by the light source of the transmitting device, wherein the receiving device is configured such that the at least one light sensor at least during some periods of time does not receive any light emitted by the lighting device. The method 100 comprises varying the intensity of the light emitted by the light source so as to include information in light emitted by the light source, 110. The method 100 comprises the at least one light sensor sensing light at least within a wavelength range of light emitted by the light source of the transmitting device, and converting the light sensed by the at least one light sensor into at least one received signal, 120. The method 100 comprises processing the at least one received signal so as to determine the information included in the light emitted by the light source, 130. The method may then end.

In conclusion a system is disclosed, which comprises a transmitting device and a receiving device. The transmitting device comprises a light source configured to vary the intensity of the emitted light so as to include information in light emitted by the light source. The receiving device comprises a lighting device configured to emit light at least during some periods of time. At least one light sensor of the receiving device is configured to sense light emitted by the light source and convert it into at least one received signal. The receiving device is configured such that the at least one light sensor at least during some periods of time does not receive any light emitted by the lighting device. The at least one received signal can be processed so as to determine the information included in the light emitted by the light source.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A system comprising:
a transmitting device comprising a light source configured to vary the intensity of the light emitted by the light source so as to include information in light emitted by the light source; and
a receiving device comprising:
a lighting device configured to emit light at least during some periods of time;
at least one light sensor configured to sense light at least within a wavelength range of light emitted by the light source of the transmitting device and convert the sensed light into at least one received signal, and
a processor configured to process the at least one received signal so as to determine the information included in the light emitted by the light source, and
wherein the transmitting device comprises a display configured to emit light, wherein the light source of the transmitting device is included in, or is constituted by, the display.

2. A system according to claim 1, wherein the lighting device of the receiving device is configured to controllably emit light or to not emit light, and wherein the lighting device is configured to emit light during a plurality of first sequential periods of time and to not emit light during a plurality of second sequential periods of time, wherein the at least one light sensor is configured to receive light emitted by the light source of the transmitting device during the plurality of second periods of time.

3. A system according to claim 2, wherein the at least one light sensor is configured to receive light emitted by the light source of the transmitting device only during the plurality of second periods of time.

4. A system according to claim 1, wherein the lighting device of the receiving device is configured to emit light within at least one wavelength range, and wherein the at least one light sensor is configured to not sense any light within the at least one wavelength range of light emitted by the lighting device.

5. A system according to claim 1, wherein the information included in the light emitted by the light source comprises information that can be used to control operation of the lighting device of the receiving device, wherein the processor is configured to control operation of the lighting device of the receiving device on the basis of the determined information.

6. A system according to claim 5, wherein:
the processor of the receiving device is configured to control at least one of intensity and color of the light emitted by the lighting device of the receiving device;
the transmitting device is configured to determine the date and the local time at the geographical location of the transmitting device, wherein the information included in the light emitted by the light source comprises information regarding the date and the local time at the geographical location of the transmitting device; and
the processor of the receiving device is configured to control at least one of intensity and color and the light emitted by the lighting device of the receiving device on the basis of the geographical location of the transmitting device and the date and the local time at the geographical location of the transmitting device.

7. A system according to claim 2, wherein the plurality of first sequential periods of time are non-consecutive and the plurality of second sequential periods of time are non-consecutive, wherein at least some of the plurality of first sequential periods of time and at least some of the plurality of second sequential periods of time together form a continuous period of time, wherein each of said second periods of time is between two of said first periods of time.

8. A system according to claim 2, wherein the durations of the plurality of first sequential periods of time are the same and the durations of the plurality of second sequential periods of time are the same, and wherein the duration of the respective ones of the plurality of second sequential periods of time is 1/20 or less of the duration of the respective ones of the plurality of first sequential periods of time.

9. A system according to claim 1, wherein the light source of the transmitting device is configured to vary the intensity of the light emitted by the light source such that the variation of the intensity of the emitted light cannot be perceived by the naked eye of a human.

10. A system according to claim 1, wherein the transmitting device comprises a smartphone, wherein the light source of the transmitting device is included in, or is constituted by, a light source of the smartphone.

11. A system according to claim 10, wherein the smartphone is configured to be coupled to a communication network, wherein the communications network permits the smartphone to retrieve information indicative of the date and the local time at the geographical location of the transmitting device, and wherein the smartphone is configured to retrieve the information indicative of the date and the local time at the geographical location of the transmitting device from the communications network.

12. A transmitting device comprising a light source configured to vary the intensity of the light emitted by the light source so as to include information in light emitted by the light source, the transmitting device being configured to be used in conjunction with a system according to claim 1.

13. A receiving device configured to be used in conjunction with a system according to claim 1, and to receive light emitted by the light source of a transmitting device, the receiving device comprising:
a lighting device configured to emit light at least during some periods of time;
at least one light sensor configured to sense light at least within a wavelength range of light emitted by the light source of the transmitting device and convert the sensed light into at least one received signal, wherein the receiving device is configured such that the at least one light sensor at least during some periods of time does not receive any light emitted by the lighting device; and
a processor configured to process the at least one received signal so as to determine the information included in the light emitted by the light source.

14. A method for light communication between a transmitting device comprising a light source and a receiving device comprising a lighting device configured to emit light at least during some periods of time, the receiving device further comprising at least one light sensor, configured to sense light at least within a wavelength range of light emitted by the light source of the transmitting device, said transmitting device comprising a display configured to emit light, wherein the light source of the transmitting device is included in, or is constituted by, the display, and wherein the receiving device is configured such that the at least one light sensor at least during some periods of time does not receive any light emitted by the lighting device, the method comprising:
varying the intensity of the light emitted by the light source so as to include information in light emitted by the light source;
the at least one light sensor sensing light at least within a wavelength range of light emitted by the light source of the transmitting device, and converting the light sensed by the at least one light sensor into at least one received signal; and
processing the at least one received signal so as to determine the information included in the light emitted by the light source.
